(19) United States
(12) Patent Application Publication
(10) Pub. No.: US 2014/0258808 A1
(43) Pub. Date: Sep. 11, 2014

(54) MEMORY DEVICE AND MEMORY CONTROLLER

(71) Applicant: Kabushiki Kaisha Toshiba, Minato-ku (JP)

(72) Inventor: Hidetomo AKIDUKI, Miura-shi (JP)

(21) Appl. No.: 13/919,204

(22) Filed: Jun. 17, 2013

Related U.S. Application Data
(60) Provisional application No. 61/776,235, filed on Mar. 11, 2013.

(51) Int. Cl. G06F 11/10

(52) U.S. Cl. CPC G06F 11/1068
USPC 714/763

(57) ABSTRACT

According to one embodiment, a memory device includes a memory to store data per page and a controller. The controller is configured to add management data used by the controller to write-data to generate an encoder input, and generate an error correction code in accordance with the encoder input. The controller is further configured to generate an encoder output from the encoder input and the error correction code, remove a part of the management data from the encoder output to generate a memory input, and write the memory input in the memory.

### CROSS-REFERENCE TO RELATED APPLICATIONS

This application claims the benefit of U.S. Provisional Application No. 61/776,235, filed Mar. 11, 2013, the entire contents of which are incorporated herein by reference.

### FIELD

Embodiments described herein relate generally to a memory device and a memory controller.

### BACKGROUND

Memory controllers to control a memory are known.

### BRIEF DESCRIPTION OF THE DRAWINGS

FIG. 1 is a block diagram of a memory device according to a first embodiment.

FIG. 2 is a block diagram of a memory of the first embodiment.

FIG. 3 is a circuit diagram of an example block.

FIG. 4 illustrates transition of data formed in the first embodiment.

FIG. 5 illustrates the flow of operation in the memory device of the first embodiment.

FIG. 6 illustrates transition of data formed in the second embodiment.

FIG. 7 is the block diagram of the memory device and a host device according to a fourth embodiment.

### DETAILED DESCRIPTION

In general, according to one embodiment, a memory device includes a memory to store data per page and a controller. The controller is configured to add management data used by the controller to write-data to generate an encoder input, and generate an error correction code in accordance with the encoder input. The controller is further configured to generate an encoder output from the encoder input and the error correction code, remove a part of the management data from the encoder output to generate a memory input, and write the memory input in the memory.

Memory controllers serve as an interface between a memory and an external device of the memory (a host device, for example). A memory controller receives instructions to write as well as data (write data) to be written into the memory from the external device. The memory controller writes the write data into the memory in response to these instructions. The memory controller, in addition to write data, also writes additional information into the memory. Such information includes parities for error correction with error correction codes (ECCs) and management data (redundant data). The management data is required to manage the memory, and is used by the memory controller.

Memory controllers have flexibility to some extent to have capabilities to control various memories. In contrast, memories may have different units for writes in accordance with their specification. For this reason, some combinations of memory controller and memory may result in the size of a set of write data, parities, and management data being larger than the write unit of the memory. With such a combination, the memory controller cannot execute write to the memory. Therefore, such a memory controller and a memory with unmatched sizes cannot be combined. This inconvenience will not occur if a dedicated memory controller is prepared for each memory of each specification. Such a solution is, however, unrealistic because of, for example, costs, time, and efficiency.

Embodiments will now be described with reference to the figures. Components with substantially the same functionality and configuration will be referred to with the same reference numbers and duplicate descriptions will be made only when required. Moreover, a description for a particular embodiment is applicable to other embodiments. Note that the figures are schematic. Moreover, each embodiment described below is used to only illustrate a device and/or method to implement a technical idea of this embodiment, which is not limited as the following examples. Moreover, each functional block may be implemented as hardware, computer software, or a combination of both. For this reason, in order to clearly illustrate this interchangeability of hardware and software, descriptions will be made in terms of their functionality in general. Those skilled in the art may implement the functional blocks in varying ways for each particular application, but all implementation approaches are included in the scope of the embodiments. Moreover, it is not essential that the functional blocks are distinguished from one another as described blow in specific examples. For example, some of the functions may be implemented by functional blocks different from those illustrated below. Furthermore, an illustrated functional block may be divided into functional sub-blocks.

### First Embodiment

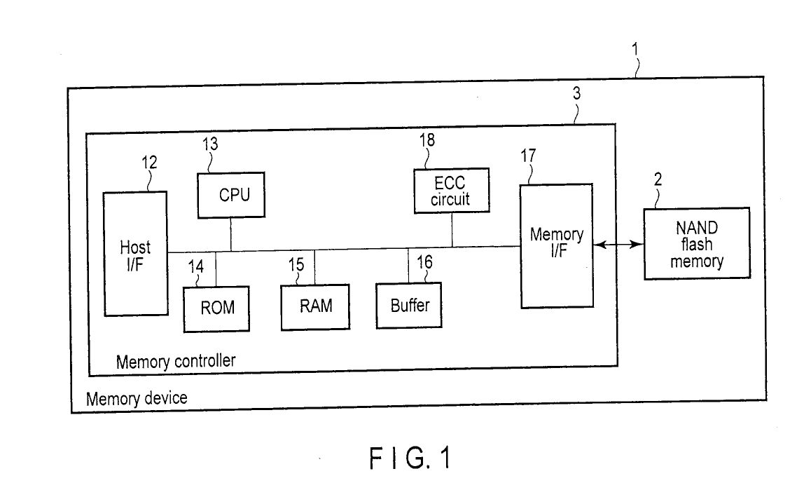

FIG. 1 is a block diagram of a memory device according to the first embodiment. The memory device 1 includes a semiconductor memory 2 and a memory controller 3. The memory device 1 is an SD card, for example. The memory device 1 communicates with a host device (not shown).

The memory controller 3 receives, for example, write commands, read commands, and erase commands from the host device, and accesses the memory 2 in accordance with the commands. The memory controller 3 includes a host interface (I/F) 12, a central processing unit (CPU)13, a read only memory (ROM)14, a random access memory (RAM)15, a buffer 16, a memory interface 17, and an error correction circuit (ECC circuit) 18. They are coupled by a bus.

The host interface 12 allows the memory device 1 to be interfaced with a host device. The CPU 13 manages operation of the whole memory device 1 in accordance with control programs. The ROM 14 stores firmware, such as control programs used by the CPU 13. The RAM 15 is used as a work area for the CPU 13, and stores, for example, control programs and various kinds of tables. The buffer 16 temporarily stores data. The memory interface 17 allows the memory controller 3 to be interfaced with the memory 2.

The ECC circuit 18 includes an ECC encoder and an ECC decoder. The ECC encoder generates error correction codes for parities from received data in accordance with predetermined rules for producing error correction codes. The ECC decoder corrects an error or errors of data in accordance with received data and its parities.

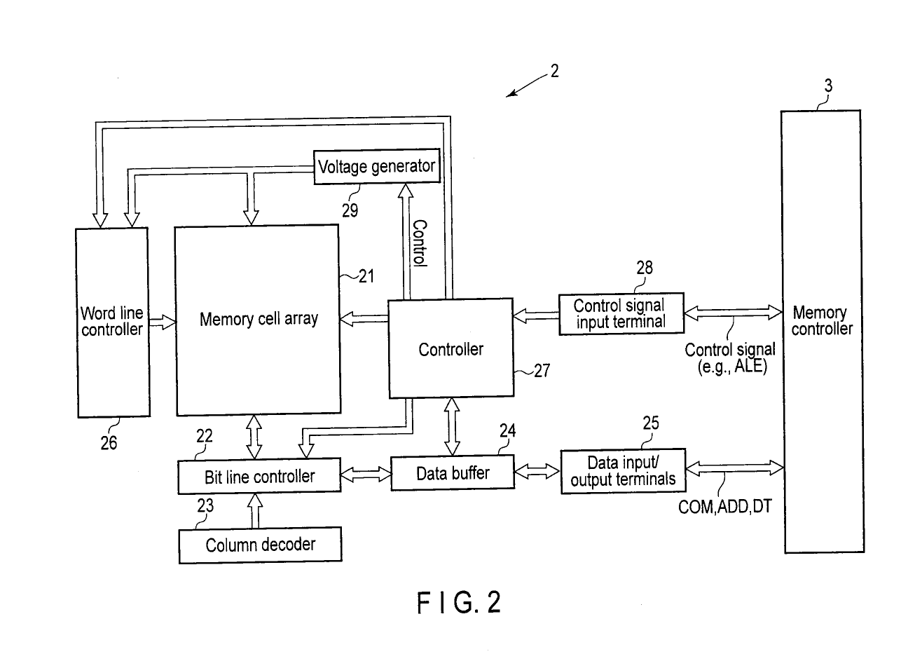

FIG. 2 is a block diagram of the memory of the first embodiment. The memory 2 is a NAND flash memory, for example. As shown in FIG. 2, the memory 2 includes a memory cell array 21, a bit line controller 22, a column decoder 23, a data buffer 24, data input/output terminals 25, a word line controller 26, a controller 27, a control signal input terminal 28, and a voltage generator 29. The memory 2 can store data of two or more bits per memory cell. The memory 2 can execute writes and reads in both a multi-bits/cell storage mode (a multi-level mode) and a bit/cell storage mode (a binary mode).

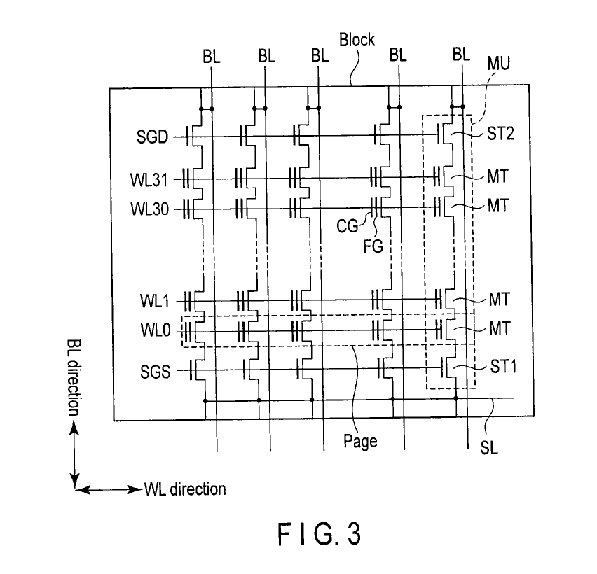

The memory cell array 21 includes blocks, word lines, bit lines, a source line, etc. As shown in FIG. 3, a block includes memory cell columns MU. Each memory cell column MU includes cell transistors MT coupled in series, and select transistors ST1 and ST2 coupled to respective ends of this serial structure. The transistor ST1 is coupled to the source line, and transistor ST2 to a corresponding bit line BL. The memory cell array 21 erases data per block.

Each cell transistor MT has a tunnel insulator, a charge storage layer, an intermediate insulator and a control electrode (a word line) stacked on a well in a semiconductor substrate, and source/drain areas. Each cell transistor MT has a threshold voltage that varies in accordance with the number of electrons in the charge storage layer, and stores data of one of eight levels in accordance with the threshold voltage. Control electrodes of respective cell transistors MT belonging to the same row are coupled to the same word line WL. The memory space of cell transistors MT coupled to the same word line WL, or a physical unit, forms pages. The memory cell array 21 reads data per page. Writes are executed per page or pages in a physical unit, collectively.

Each of the transistors ST1 and ST2 includes a gate insulator and a gate electrode stacked on the semiconductor substrate, and source/drain areas. Gates of respective transistors ST1 belonging to the same row are coupled to a select gate line SGS. Gates of respective transistors ST2 belonging to the same row are coupled to a select gate line SGD.

Referring back to FIG. 2, the bit line controller 22 reads data of the memory cells through the bit lines BL and detects the states of the memory cells through the bit lines BL. The bit line controller 22 applies write (or program) voltages to the memory cells through the bit lines BL to write (or program) data in the memory cells. The bit line controller 22 includes components, such as sense amplifiers and data storage circuits (not shown). The sense amplifiers amplify potentials on the bit lines BL. A particular data storage circuit is selected by the column decoder 23. Data read to the selected data storage circuit from the memory cells is output to outside the memory 2 from the data input/output terminals 25 through the data buffer 24.

The data input/output terminals 25 are coupled to the memory controller 3. The data input/output terminals 25 receive various commands COM to control operation of the memory 2, addresses ADD, and data DT from the memory controller 3, and outputs data DT to the memory controller 3. Write data DT input to the data input/output terminals 25 is supplied to a selected particular data storage circuit via the data buffer 24. The commands COM and addresses ADD are supplied to the controller 27.

The word line controller 26 receives from the voltage generator 29 voltages for reads, writes, or erases. The word line controller 26 applies received voltages to selected word lines WL in accordance with the control performed by the controller 27.

The controller 27 controls the memory cell array 21, bit line controller 22, column decoder 23, data buffer 24, word line controller 26, and voltage generator 29. The controller 27 is coupled to the control signal input terminal 28, and is controlled by control signals input through the control signal input terminal 28 from the memory controller 3, such as an address latch enable (ALE), a command latch enable (CLE), a write enable (WE), and a read enable (RE).

The voltage generator 29 provides voltages to the memory cell array 21 and word line controller 26 in accordance with the control performed by the controller 27 during operations such as a write, a read, and an erase. Specifically, the voltage generator 29 generates voltages VPGM, VPASS, and VISO during data writes, and a voltage VERA during data erases.

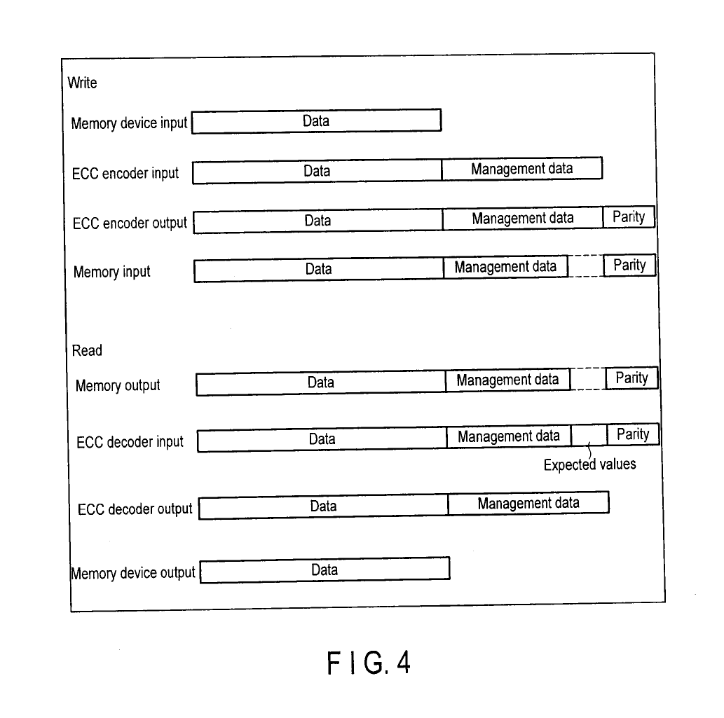

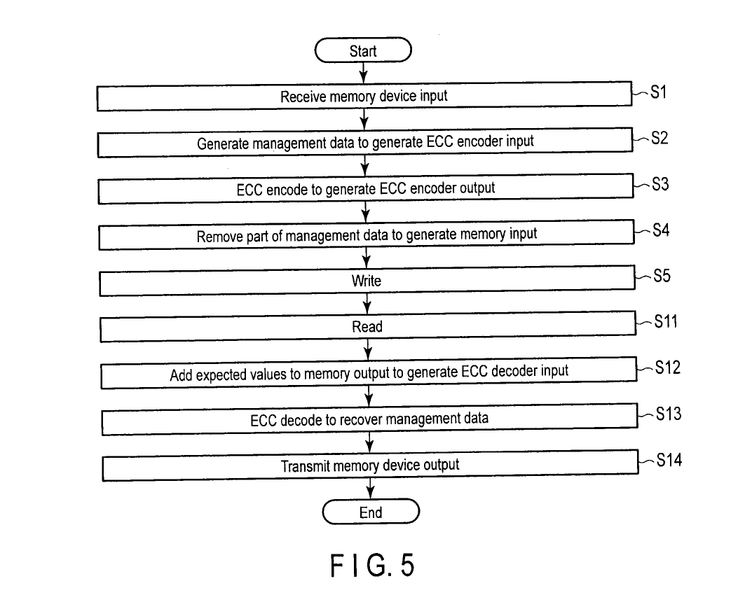

Referring now to FIGS. 4 and 5, a write and a read in the memory device of the first embodiment will now be described. FIG. 4 illustrates a transition of data formed in the first embodiment with time. FIG. 5 illustrates the flow of operation in the memory device of the first embodiment. The memory controller 3 is configured to execute a process illustrated in FIGS. 4 and 5 and described in the following. Specifically, the CPU 3 is configured to execute the following process in accordance with programs to control operation of the memory controller 3, and the programs are configured to cause the CPU 3 to execute the following process.

As shown in FIGS. 4 and 5, the memory controller 3 receives a write instruction and write data (or a memory device input) from an external device (a host device, for example) (step S1). Write data has a size of 1 Kbyte.

In step S2, the memory controller 3 generates management data associated with the write data. Management data is used to describe features about corresponding write data, and is used by the memory controller 3. Management data has a size of 10 byte. The memory controller 3 adds the management data behind the corresponding write data to generate an ECC encoder input.

In step S3, the memory controller 3 supplies the ECC encoder input to the ECC circuit 18. The ECC encoder in the ECC circuit 18 generates parities from the ECC encoder input in accordance with a predetermined principle. With parities, an error or errors in a corresponding ECC encoder input can be corrected. The set of an ECC encoder input and the corresponding parity that follows is referred to as an ECC encoder output. An ECC encoder output has a size larger than that of a page of the memory 2.

The memory controller 3 then writes the ECC encoder output in the memory 2. The memory controller 3, however, writes a memory input instead of the ECC encoder output in the memory 2. To this end, the memory controller 3 generates the memory input from the ECC encoder output (step S4). A memory input is an ECC encoder output with a part of management data removed. Specifically, the memory controller 3 writes the entire set of the write data and the parities in the memory 2, and writes a part of management data in the memory 2.

The unwritten part of the management data (referred to as unwritten management data, hereinafter) is suitably a part highly likely to carry a limited or predetermined pattern rather than that carrying random data. For example, it can be a part indicating characteristics which hardly or not at all vary in accordance with the state or contents of the corresponding write data. For example, it can be a part expected or known to have particular values such as 1s in many cases.

Specifically, it can be Valid bits which indicate a valid section of write data, for example. More specifically, it is as follows. Generally, ECC encoders such as the ECC circuit 18 are configured to calculate parities for data of a fixed size. On the other hand, some host devices transmit to the memory device 1 write data with a size smaller than the ECC encoding unit. When used with such a host device, the memory controller 3 adds invalid data to received write data to generate new write data with a size of the ECC encoding unit. This invalid data for size adjustment consists of bits of the same value, for example. In such an example, the memory controller 3 puts information indicative of whether each of the first half of write data (or write data received from the host) and the second half of write data (or invalid data) is valid or invalid in management data in ECC encoder input data. Specifically, in the current context, the first and second halves of write data are valid and invalid respectively, and bits indicative of this are included in management data. The set of bits indicative of validity or invalidity of the first and second halves is referred to as a valid flag herein. A valid flag includes a total of 2 byte: 1 byte for each of the first and second halves. Note that when write data from a host device originally has the same size as that of the ECC encoding unit, the valid flag indicates validity for each of the first and second halves. This valid flag is not written into the memory 2.

The type and size of the valid flag is determined to make memory inputs smaller than the page based on the size of write data and type of management data, etc. from host devices.

In step S5, the memory controller 3 supplies the memory input to the memory 2, and instructs the memory 2 to write it. The memory 2 writes the memory input in a particular page of the memory cell array 21.

When instructed to read by a host device, the memory controller 3 reads the instructed data from the memory 2 (step S11). The read data (or a memory output) is equal to the ECC encoder output with the unwritten management data removed.

The memory controller 3 attempts to correct an error or errors in the memory output with the ECC decoder in the ECC circuit 18. To this end, the memory controller 3 supplies the memory output to the ECC decoder 18. The memory controller 3 inserts expected values in a part of the memory output where the unwritten management data of the memory output should have existed, or in a part corresponding to the unwritten management data in the ECC encoder output, to generate an ECC decoder input (step S12). The expected values are values which the unwritten management data is expected to have in accordance with features of the unwritten management data. For example, the expected values have the same value (1, for example). The ECC decoder input is supplied to the ECC decoder 18 by the memory controller 3. The ECC decoder input is not necessarily the same as the ECC encoder output in the unwritten management data. This is because, though the unwritten management data in the ECC decoder input is determined based on the fact that it has substantially constant values, it is merely an estimate.

The ECC decoder 18 tries to correct an error or errors in the ECC decoder input in accordance with the parities in it. Specifically, it checks an error or errors in a section other than the parities in the ECC decoder input in accordance with the parities. If the check results indicate that the part of the management data unwritten in the memory is not the same as the expected values, at least a part of the unwritten management data is determined to be erroneous from the parities. Further, the ECC decoder 18 corrects a value or values of the part in the unwritten management data determined to be erroneous, or reverses the value or values. For example, if a particular value (a value in the ECC encoder output) is originally 0 and its expected value is 1, then the value is determined to be erroneous and corrected to 0. Thus, the unwritten management data is restored. The ECC decoder 18 outputs an ECC output including data and the restored management data (step S13).

In step S14, the memory controller 3 transmits read data (or a memory device output) to the host device in accordance with the management data. For example, the memory controller 3 recognizes from the management data that the read data includes invalid data, and supplies the read data without the invalid data to the host device.

To parts other than the unwritten management data of non-parity part in the ECC decoder input, usual error correction is executed.

The description has been so far given of an example with a static unit of processing of the ECC circuit 18 (i.e., encoding and decoding) and static use of unwritten management data. The first embodiment, however, is applicable to examples of variable process units, for example. Specifically, the memory controller 3 and ECC circuit 18 can dynamically change the size of generated parities (i.e., correction capability). When errors of data read from the memory 2 have increased due to deterioration of the memory 2, the memory controller 3 and ECC circuit 18 generate an increased number of parities during new writes after that. Such adoption may make a memory input larger than the page. In that case, the memory controller 3 dynamically changes the definition of the unwritten management data in order to accommodate the increased parities.

As described above, according to the first embodiment, the memory controller 3 generates the parity from the write data and management data, and writes the all write data and parity, and only a part of the management data into the memory. The memory input reduces to be smaller than that of the write unit of the memory. This allows for a write to the memory 2 even when the size of the memory input exceeds the write unit of the memory 2. Upon a read, the read memory input and the expected values inserted in the part which was not written are supplied to the ECC decoder 18. If the unwritten values and expected values do not match, the ECC decoder 18 corrects the error or errors in the corresponding section in the expected values. The corrected values are inserted in the part which was not written into the memory. Thus, the memory controller 3 can restore the management data which was not written. In other words, even when the total size of write data, management data, and parity exceeds the write unit of the memory, writes and reads can be executed. This broadens the applicability of the memory controller 3.

A part of the error correction capability of the ECC circuit 18 is consumed for restoration of a part of the management data, which decreases the correction capability for errors in a part other than the unwritten part of data supplied to the memory. It is, however, thought that the advantages realised by the improved adaptability of the memory controller 3 outweigh the disadvantages. Therefore, the first embodiment is valid in practical terms.

### Second Embodiment

The second embodiment is related to a bits/cell memory system.

As described above, the memory 2 can store data of two or more bits per cell. The following description assumes an example of the memory 2 storing data of two bits per cell. The second embodiment, however, is also applicable to storing of data of three or more bits.

In multi-level NAND flash memories including the memory 2, multiple pages are assigned to a physical unit. A lower page and an upper page are defined in this context. They may be different in error occurrence rate. Assume that, as an example, writes to lower pages have a reliability higher than those to upper pages, and the memory 2 may also have such a characteristic.

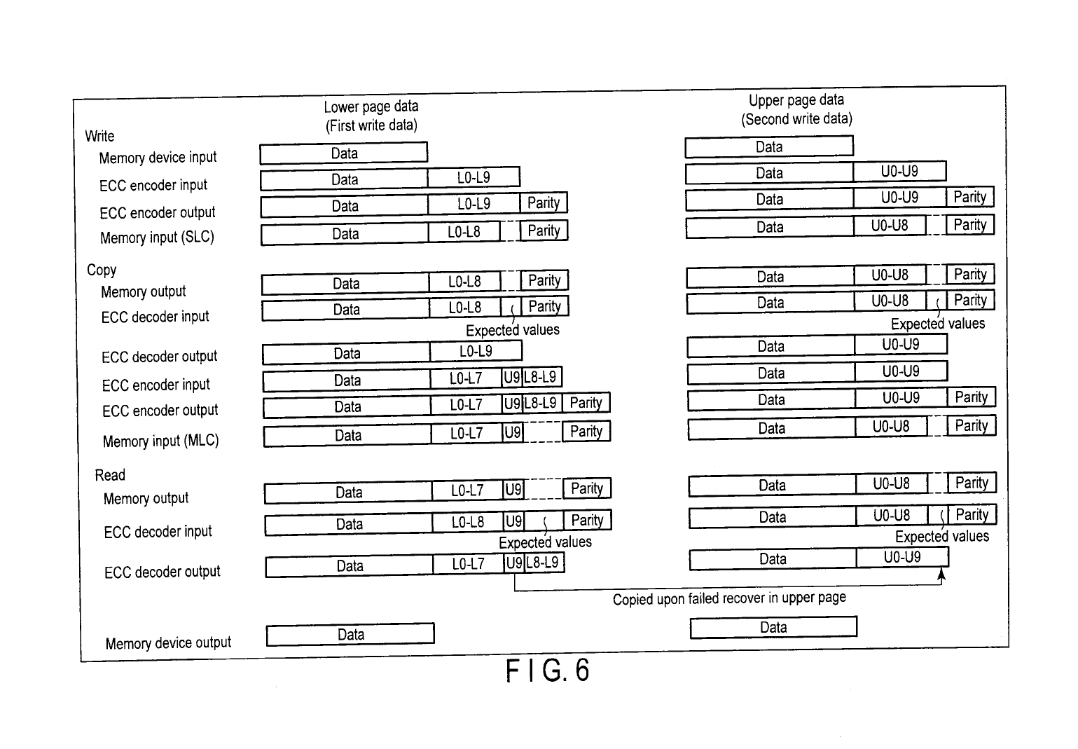

The memory controller 3 may temporarily write write data from the host device in a binary mode, and copy it to another area in four-level mode (two-bits/cell storing) at various timings. Generally, writes in the binary mode have a reliability higher than that in a multi-level mode. For writes into lower pages in the reliable binary mode, a 27-bit/Kb parity, for example, is sufficient, whereas 43-bit/Kb parity, for example, is required for writes to upper pages. In the second embodiment, the memory controller 3 uses the first embodiment in the form based on the characteristics described so far. The memory device 1 of the second embodiment has the same configuration (components) as that in the first embodiment though the memory device 1 of the second embodiment is configured to execute the process illustrated in FIG. 6 and described in the following.

FIG. 6 illustrates a transition of data formed in the second embodiment. As shown in FIG. 6, the host device instructs the memory device 1 to write first write data and second write data. The memory controller 3 receives a memory device input including the first write data, and receives a memory device input including the second write data. The first and second write data each have invalid data added in accordance with the process unit of ECC if needed, and have a size of, for example, 1 Kbyte as described in the first embodiment. The first and second write data are data which will be moved to a lower page and an upper page of a physical unit.

The memory controller 3 generates 10-byte management data (referred to as lower page management data) for the lower page data to generate a lower page ECC encoder input. The lower page management data may be divided into 1-byte sections to be hereinafter referred to as the 0th section L0 with the lowest address to the ninth section L9 with the highest address in the ascending order of their addresses, respectively. The memory controller 3 also generates 10-byte management data (referred to as upper page management data) for the upper page data to generate an upper page ECC encoder input. The upper page management data may be divided into 1-byte sections to be hereinafter referred to as the 0th section U0 with the lowest address to the ninth section U9 with the highest address in the ascending order of their addresses, respectively.

The memory controller 3 then adds parities to the lower page ECC encoder input through the ECC encoder 18 to generate a lower page ECC encoder output. The memory controller 3 also adds parities to the upper page ECC encoder input through the ECC encoder 18 to generate an upper page ECC encoder output. Each of the lower page and upper page encoder outputs has a size larger than that of the page of the memory 2.

The memory controller 3 then writes the lower page ECC encoder output and upper page ECC encoder output into the memory 2 in the binary mode. The lower page ECC encoder output and upper page ECC encoder output are read to be copied in the four-level mode at a particular timing. FIG. 6 illustrates a transition of data with time from the top toward the bottom of the figure. On the other hand, transitions of associated features of the lower page data and upper page data are illustrated on the right-hand side and left-hand side, to aid in comprehension. The orders of both with time, however, are not necessarily the same as those illustrated in FIG. 6.

The first embodiment is used for writes and reads of the lower page ECC encoder output and upper page ECC encoder output in the binary mode. Specifically, the memory controller 3 removes a part of the management data (for example, the ninth section L9) from the lower page ECC encoder output to generate a lower page memory input. The memory controller 3 then writes the lower page memory input in the memory 2 and then reads it, and uses the ECC decoder 18 to restore the ninth section L9 to obtain a lower page ECC decoder output. Similarly, the memory controller 3 removes a part of the management data (for example, the ninth section U9) from the upper page ECC encoder output to form an upper page memory input. The memory controller 3 then writes the upper page memory input in the memory 2 and then reads it, and uses the ECC decoder 18 to restore the ninth section U9 to obtain an upper page ECC decoder output.

Upon copying in the four-level mode, the memory controller 3 inputs all the upper page data and all the upper page management data into the ECC encoder 18. The upper page ECC encoder input has a total size of 1 Kbyte+10 byte, which consists of 1 Kbyte of upper page data and 10 byte of upper page management data. In contrast, the memory controller 3 inputs into the ECC encoder 18 all the lower page data, all the lower page management data and a part of the upper page management data (referred to as insertion management data). The lower page ECC encoder input has a total size of 1 Kbyte+11 byte, which consists of 1 Kbyte of lower page data, 10 byte of lower page management data, and 1 byte of insertion management data. The inserted part is, for example, the ninth section U9, and is inserted, for example, just before the eighth and ninth sections which will not be written in the memory, as will be described later.

The ECC encoder 18 generates parities (referred to as upper page parities) from the upper page ECC encoder input. The set of the upper page ECC encoder input and the following added upper page parities (upper page ECC encoder output) has a size larger than that of the size of the page. The ECC encoder 18 also generates parities (referred to as lower page parities) from the lower page ECC encoder input. The set of the lower page ECC encoder input and the following added lower page parities (lower page ECC encoder output) has a size larger than the size of the page.

The memory controller 3 then removes a part of the management data (for example, the ninth section U9) from the upper page ECC encoder output to generate an upper page memory input. The removed section U9 is identical to the insertion management data. The memory controller 3 writes the generated upper page memory input in the memory 2. The upper page memory input has a size smaller than or equal to the page size. In other words, the unwritten management data in the upper page is determined to allow the upper page memory input to have a size smaller than or equal to the page. The selection of unwritten management data in the upper page is based on the method of the first embodiment. The memory controller 3 also removes a part of the management data (for example, the eighth and ninth sections L8 and L9) from the lower page ECC encoder output to generate a lower page memory input. The memory controller 3 writes the generated lower page memory input in the memory 2. The lower page memory input has a size smaller than or equal to the page size. In other words, the unwritten management data in the lower page is determined to allow the lower page memory input to have a size smaller than or equal to the page. The selection of unwritten management data in the lower page is based on the method of the first embodiment. This completes the copying of the upper page data and lower page data.

The written lower page data is read in the same manner as in the first embodiment. Specifically, the memory controller 3 reads the lower page memory input. This read data (a lower page memory output) is the lower page ECC encoder output with the unwritten management data (the eighth and ninth sections L8 and L9) removed. The memory controller 3 then inserts expected values in a part of the lower page memory output in which the unwritten management data should have existed to generate a lower page ECC decoder input. The ECC decoder 18 restores the unwritten management data of the lower page management data to output a lower page ECC decoder output including the restored unwritten management data. The memory controller 3 then uses the restored management data to transmit lower page data to the host device.

The upper page data written as described above is read as follows using the first embodiment. Specifically, the memory controller 3 reads the upper page memory input. This read data (an upper page memory output) is the upper page ECC encoder output with the unwritten management data (the ninth section U9) removed. The memory controller 3 then inserts expected values in a part of the upper page memory output in which the unwritten management data should have existed to generate an upper page ECC decoder input. The ECC decoder 18 restores the unwritten management data of the upper page management data. If the restoration succeeds, the ECC decoder 18 outputs an upper page ECC decoder output including the restored unwritten management data. The memory controller 3 then uses the restored management data to transmit upper page data to the host device.

In contrast, if the restoration of the unwritten management data fails, the memory controller 3 executes a read from the lower page in the same physical unit to obtain the unwritten management data (the insertion management data) of the upper page in it. The memory controller 3 inserts the obtained unwritten management data in the part of the upper page memory output in which the unwritten management data should have existed to supply the obtained structure to the ECC decoder 18.

The description so far has been given for an example of temporal storing of lower and upper page data in the binary mode. The memory controller 3, however, may write the lower and upper page data in the memory 2 in a multi-level mode in accordance with the above description without going through the binary mode. Moreover, the unit of input to the ECC encoder 18 may vary between writes in the binary mode and those in a multi-level mode. Furthermore, in an example where data written in the binary mode is copied in a multi-level mode, the data to be copied may be different from data written in the binary mode. Specifically, data written in multiple pages in the binary mode may be rearranged to generate data for a multi-level mode. Moreover, the size of the management data duplicated in the same physical unit is not limited to the above example. For example, a part of the ninth section U9 of the upper page management data may be duplicated. In sum, a part of management data to be written in a particular page only needs to be duplicated in another page in the same physical unit in accordance with the above description, and features other than this do not limit the second embodiment.

As described above, according to the second embodiment, the memory controller 3 uses the entire amount of management data to generate parities, writes only a part of the management data in the memory, and restores the unwritten part of the management data from the parities as in the first embodiment. This can produce the same advantage as those by the first embodiment. Moreover, according to the second embodiment, a part of management data of a less unreliable page is also written in a more reliable page. Upon failure of a read in the less reliable page, the duplicate is read from the more reliable page. This removes the necessity to use the ECC correction capability for the duplicate read from the more reliable page in the less reliable page. This results in an increased permissibility for errors in the less reliable page as a whole and therefore increased the capability to deal with read errors.

A part of management data duplicated in another page in the same physical unit may not be used to generate parities. Specifically, a part of the management data to be duplicated is removed from an ECC encoder input, and is not input into the ECC encoder 18.

### Third Embodiment

The third embodiment is related to an example modification of the first or second embodiment, and to adjustment of expected values used to restore unwritten management data. The memory device 1 of the third embodiment has the same configuration (features) as that of the first embodiment though the memory device 1 of the third embodiment is configured to execute the process described in the following.

In the first or second embodiment, a part of the error correction capability by the ECC circuit 18 is used to restore unwritten management data. Because of this, when there are many errors in a section other than unwritten management data, the correction capability to restore unwritten management data may exceed the capability of the ECC circuit 18. Assume that, as an example, unwritten management data has a size of 1 byte, and includes a three-bit portion for storing valid information and a five-bit portion of don't care (undefined). All undefined five bits only take the same value (for example, 1). Furthermore, assume, as an example, that the ECC circuit 18 has a 43-bit correction capability and a section other than the unwritten management data includes 41-bit errors. With such conditions, if whole three-bit portion of the unwritten management data are erroneous, then the data to be input into the ECC decoder 18 includes 44-bit (=41+3) errors. This is beyond the capability of the ECC decoder 18. To address this, the memory controller 3 changes some of the expected values of the three-bit portion of the unwritten management data. For example, 111 may be changed to 110. If the last bit in the changed expected values matches the original, the number of errors in the unwritten management data decreases to two bits. This results in the data input to the ECC decoder 18 including 41+2=43 bit, and this value falls within the capability of the ECC decoder 18.

Thus, when the restoration of the unwritten management data and error correction are impossible, one or more of the expected values of the unwritten management are reversed, which allows for the restoration and correction. The size of the unwritten management data is small, and therefore, simply reversing one or more of the expected values can easily make the restoration and error correction possible.

As described above, according to the third embodiment, the same advantages can be obtained as those of the first or second embodiment to which the third embodiment is applied. Furthermore, according to the third embodiment, when restoration and error correction of unwritten management data are impossible, one or more of the expected values of the unwritten management data are changed. This may make restoration and correction possible. This in turn can account for a decrease in the error correction capability due to the restoration of the unwritten management data as performed in the first or second embodiment.

### Fourth Embodiment

Host devices may have an error correction capability. In general, they have an error correction capability higher than that of a memory device with which they communicate. Such host devices can execute error correction instead of, or in addition to, the memory device. The fourth embodiment is related to such an example.

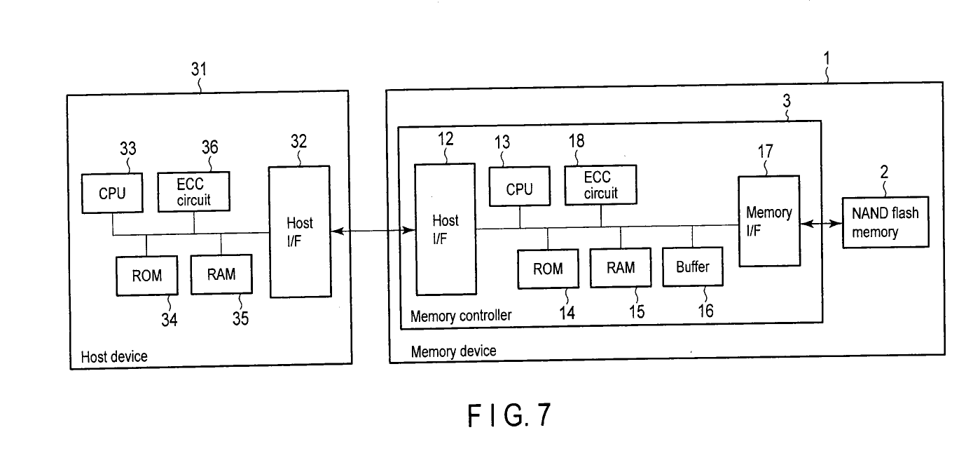

The fourth embodiment is applicable to the first, second or third embodiment. FIG. 7 is a block diagram of a memory device and a host device according to the fourth embodiment. As shown in FIG. 7, the memory device 1 communicates with a host device 31. The host device 31 includes a host interface 32, a CPU 33, a ROM 34, a RAM 35, and an ECC circuit 36, etc.

They are coupled by a bus.

The host interface 32 has a configuration to allow the host device 31 to be interfaced with the memory device 1. The CPU 33 manages operation of the whole host device 31 in accordance with control programs. The ROM 34 stores firmware, such as control programs used by the CPU 33. The RAM 35 is used as a work area for the CPU 33, and stores, for example, control programs or various kinds of tables.

The ECC circuit 36 includes an ECC encoder and an ECC decoder. The ECC encoder generates parities (error correction code) from the received data in accordance with predetermined rules for producing error correction codes. The ECC decoder corrects an error or errors of data in accordance with the received data and its parities. The ECC circuit 36 executes error correction in addition to the ECC circuit 18 in the memory device 1. Specifically, the ECC circuit 36 uses data to be written to the memory device 1 to generate parities. The host device 31 then supplies the memory device 1 with a set of the data and parities. The memory device 1 treats the received data as the write data in the first, second, or third embodiment, and processes it.

Moreover, when the management data used by the host device 31 is included in the data to be written to the memory device 1, the sum of the write data and parities may exceed a data size defined by the transfer protocol between the host device 31 and memory device 1. In such a case, the host device 31 can execute a process similar to that executed by the memory controller 3 in the first, second, or third embodiment to allow data transmitted to the memory device 1 from the host device 31 to have a size smaller than or equal to the data size of the transfer protocol.

Specifically, the host device 31 can remove some data from the write data and parities transmitted to the memory device 1 to make them equal to or smaller in size than the data size of the transfer protocol to generate input data to the memory device 1. The host device 31 transmits this input data to the memory device 1 (or writes it). During a read from the memory device 1, the host device 31 inserts expected values in data read from the memory device 1 in a part (unwritten data part) removed during the input data generation to generate a decoder input of the ECC circuit 36. An error correction process is executed to the decoder input by the ECC circuit 36 to restore the unwritten data part.

According to the fourth embodiment, the same advantages can be obtained as those of the first or second embodiment to which the third embodiment is applied. Furthermore, the host device 31 generates parities from write data including its management data, and supplies the write data without part of the management data of the host device 31 to the memory device 1. The host device 31 then uses the parities to restore the unwritten part of the management data. This allows for data transmission to the memory device 1 even when the sum of the write data and parities including the management data of the host device 31 exceeds the specified data size between the host device 31 and memory device 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a memory to store data per page; and
a controller configured to
add management data used by the controller to write-data to generate an encoder input,
generate an error correction code in accordance with the encoder input,
generate an encoder output from the encoder input and the error correction code,
remove a part of the management data from the encoder output to generate a memory input, and
write the memory input in the memory.

2. The device of claim 1, wherein the controller is further configured to:
read the memory input from the memory,
insert in the read memory input an expected value at a position where the removed part of the management data should exist to generate a decoder input, and
attempt to restore the part of the management data removed from the decoder input and the error correction code in the decoder input.

3. The device of claim 1, wherein the encoder output has a size larger than a size of the page.

4. The device of claim 3, wherein the memory input has a size smaller than or equal to the size of the page.

5. The device of claim 1, wherein the management data indicates information about the write data.

6. The device of claim 5, wherein:
the controller receives data instructed to be written in the memory and generates the write data from the received data, and
the management data indicates that each of parts of the write data is valid or invalid.

7. The device of claim 2, wherein:
the controller comprises an error correction circuit, and
the error correction circuit is configured to:
receive the encoder input,
generate the error correction code in accordance with the encoder input,
add the error correction code behind the encoder input to generate the encoder output,
receive the decoder input,
generate a new error correction code from the write data in the decoder input and the management data including the expected value,
use comparison between the new error correction code and the error correction code in the decoder input to attempt to correct the expected value to restore the removed part of the management data.

8. The device of claim 1, wherein:
the memory is configured to store data in a first page and a second page in a physical unit, and
the controller is configured to
add first and second management data used by the controller to first and second write data to generate first and second encoder inputs, respectively,
generate first and second error correction codes in accordance with the first and second encoder inputs, respectively,
generate a first encoder output from the first encoder input and the first error correction code,
remove a part of the first management data from the first encoder output to generate a first memory input,
generate a second encoder output from the second encoder input, the second error correction code, and the removed part of the first management data,
remove part of the second management data from the second encoder output to generate a second memory input, and
write the first and second memory inputs in the memory.

9. The device of claim 8, wherein:
the controller is further configured to:
read the first and second memory inputs from the memory,
insert in the read second memory input an expected value in a part where the removed part of the second management data should exist to generate a second decoder input,
attempt to restore the removed part of the second management data from the second decoder input and the second error correction code in the second decoder input,
insert in the read first memory input an expected value in a part where the removed part of the first management data should exist to generate a first decoder input,
attempt to restore the removed part of the first management data from the first decoder input and the first error correction code in the first decoder input, and
upon fail of restoration of the removed part of the first management data, insert, in the read first memory input in a part where the removed part of the first management data should exist, the inserted part of the first management data in a second decoder output to generate a new first decoder input, and
the second decoder output is the second decoder input with an error corrected.

10. The device of claim 2, wherein the controller is configured to:
upon fail of restoration of the removed part of the management data, change the expected value to generate a new decoder input, and
attempt to restore the removed part of the management data from the new decoder input and the error correction code in the new decoder input.

11. A controller to control a memory which stores data per page, the controller configured to:
add management data used by the controller to write-data to generate an encoder input,
generate an error correction code in accordance with the encoder input,
generate an encoder output from the encoder input and the error correction code,
remove a part of the management data from the encoder output to generate a memory input, and
write the memory input in the memory.

12. The controller of claim 11, wherein the controller is further configured to:
read the memory input from the memory,
insert in the read memory input an expected value in a position where the removed part of the management data should exist to generate a decoder input, and
attempt to restore the part of the management data removed from the decoder input and the error correction code in the decoder input.

13. The controller of claim 11, wherein the encoder output has a size larger than a size of the page.

14. The controller of claim 13, wherein the memory input has a size smaller than or equal to the size of the page.

15. The controller of claim 11, wherein the management data indicates information about the write data.

16. The controller of claim 15, wherein:
the controller receives data instructed to be written in the memory and generates the write data from the received data, and
the management data indicates that each of parts of the write data is valid or invalid.

17. The controller of claim 12, further comprising an error correction circuit configured to:
receive the encoder input,
generate the error correction code in accordance with the encoder input,
add the error correction code behind the encoder input to generate the encoder output,
receive the decoder input,
generate a new error correction code from the write data in the decoder input and the management data including the expected value,
use comparison between the new error correction code and the error correction code in the decoder input to attempt to correct the expected value to restore the removed part of the management data.

18. The controller of claim 11, wherein:
the memory is configured to store data in a first page and a second page by a physical unit, and
the controller is configured to
add first and second management data used by the controller to first and second write data to generate first and second encoder inputs, respectively,
generate first and second error correction codes in accordance with the first and second encoder inputs, respectively,
generate a first encoder output from the first encoder input and the first error correction code,
remove a part of the first management data from the first encoder output to generate a first memory input,
generate a second encoder output from the second encoder input, the second error correction code, and the removed part of the first management data,
remove part of the second management data from the second encoder output to generate a second memory input, and
write the first and second memory inputs in the memory.

19. The controller of claim 18, wherein:
the controller is further configured to:
read the first and second memory inputs from the memory,
insert in the read second memory input an expected value in a part where the removed part of the second management data should exist to generate a second decoder input,
attempt to restore the removed part of the second management data from the second decoder input and the second error correction code in the second decoder input,
insert in the read first memory input an expected value in a part where the removed part of the first management data should exist to generate a first decoder input,
attempt to restore the removed part of the first management data from the first decoder input and the first error correction code in the first decoder input, and
upon fail of restoration of the removed part of the first management data, insert, in the read first memory input in a part where the removed part of the first management data should exist, the inserted part of the first management data in a second decoder output to generate a new first decoder input, and
the second decoder output is the second decoder input with an error corrected.

20. The controller of claim 12, wherein the controller is configured to:
upon fail of restoration of the removed part of the management data, change the expected value to generate a new decoder input, and
attempt to restore the removed part of the management data from the new decoder input and the error correction code in the new decoder input.
